(19) United States
(12) Patent Application Publication
(10) Pub. No.: US 2006/0092664 A1
(43) Pub. Date: May 4, 2006

(54) Surface light source device and backlight unit having the same

(75) Inventors: Geun-Young Kim, Seoul (KR); Jae-Hyeon Ko, Suwon-si (KR); Seog-Hyun Cho, Suwon-si (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/258,162

(22) Filed: Oct. 26, 2005

(30) Foreign Application Priority Data
Nov. 4, 2004 (KR) 10-2004-89229

(51) Int. Cl. F21V 7/04

(52) U.S. Cl. 362/611

(57) ABSTRACT

A surface light source device includes a source body having a plurality of discharge spaces formed along a first direction, and electrodes for generating a dielectric barrier discharge in the discharge spaces formed on both end portions of an outer face of the light source body along a second direction substantially perpendicular to the first direction. The electrodes have capacitances that vary along the second direction. The capacitance for generating a visible ray varies in accordance with a lengthwise direction of the electrode so that the surface light source device may have improved luminance uniformity.

### CROSS REFERENCE TO RELATED APPLICATIONS

This application claims priority under 35 USC § 119 to Korean Patent Application No. 2004-89229, filed on Nov. 4, 2004, the contents of which are herein incorporated by reference in its entirety.

### BACKGROUND OF THE INVENTION

1. Field of the Invention

The present invention relates to a surface light source device and a backlight unit having the same. More particularly, the present invention relates to a surface light source device that emits a light having a plane shape and a backlight unit having the surface light source unit.

2. Description of the Related Art

Generally, a liquid crystal using a liquid crystal display (LCD) apparatus has electrical and optical characteristics. In the LCD apparatus, an arrangement of the liquid crystal varies in response to a direction of an electric field applied thereto, and a light transmittance thereof is changed in accordance with the arrangement thereof.

The LCD apparatus displays an image using the electric and optical characteristics of the liquid crystal. The LCD apparatus is advantageously smaller and lighter than a cathode ray tube (CRT) type display device. Thus, the LCD apparatus is widely used in various electronic apparatus, for example, such as a portable computer, communication equipment, a liquid crystal television receiver set, an aerospace device, etc.

To display the image, the LCD apparatus requires a liquid crystal controlling part for controlling the liquid crystal and a light supplying part for supplying a light to the light controlling part.

The liquid crystal controlling part includes a pixel electrode disposed on a first substrate, a common electrode positioned on a second substrate corresponding to the first substrate, and the liquid crystal interposed between the pixel electrode and the common electrode. The liquid crystal controlling part includes a plurality of the pixel electrodes corresponding to a resolution, and the common electrode is disposed at a position corresponding to the pixel electrodes. A plurality of thin film transistors (TFTs) is electrically connected to the pixel electrodes, respectively, to supply a different pixel voltage to each of the pixel electrodes. A reference voltage is applied to the common electrode. The pixel electrode and the common electrode include a transparent conductive material.

The light supplying part supplies the liquid crystal of the liquid crystal controlling part with the light. The light successively passes through the pixel electrode, the liquid crystal, and the common electrode. A display quality of an image that has passed through the liquid crystal is largely influenced by a luminance and a uniformity of the luminance of the light that is generated from the light supplying part. The display quality of the LCD apparatus is enhanced in proportion to the luminance and the uniformity of the luminance of the light.

The light supplying part of the conventional LCD apparatus includes a cold cathode fluorescent lamp (CCFL) having a bar shape or a light emitting diode (LED) having a dot shape. The CCFL has advantageous characteristics, for example, such as high luminance, long lifetime, and small heat value in comparison with an incandescent lamp, etc. Therefore, the LED has advantageous characteristics, for example, high luminance and so on. However, The CCFL and the LED have non-uniform luminance.

Therefore, the light supplying part having a light source such as the CCFL or the LED includes an optical member, for example, such as a light guide panel (LGP), a diffusion sheet, a prism sheet, etc., so as to enhance the uniformity of the luminance of the light that is generated from the light supplying part. Thus, there is a problem that dimensions such as a volume and a weight of the LCD apparatus having the CCFL or the LED are increased in proportion to a dimension of the optical member.

In recent years, a surface light source having a flat shape has been developed so as to solve the above problem.

FIG. 1 is a plan view illustrating a conventional surface light source device.

Referring to FIG. 1, a conventional surface light source includes a light source body 10 and electrodes 20 placed on both end portions of an outer face of the light source body 10. The light source body 10 includes a first substrate (not shown), and a second substrate (not shown) facing the first substrate. The second substrate is spaced apart from each other by a predetermined interval. A plurality of partition walls 30 is interposed between the first and second substrates to divide a space between the first and second substrates into a plurality of discharge spaces 50. A sealing member 40 is arranged between edges of the first and second substrates to separate the discharge spaces 50 from the external. A discharge gas is introduced into the separated discharge spaces 50.

To enhance luminance uniformity of the surface light source device, the electrodes 20 having a string shape or an island shape are placed on the first and second substrates or any one of the first and second substrates. Each of the electrodes 20 has a substantially same area per each of the discharge spaces 50. Thus, the surface light source device has good luminance uniformity.

However, when a surface light source device is combined with the backlight unit, luminance of light generated in end portions of the discharge space 50 corresponding to the both end portions of the electrodes 20 is greatly reduced. The reduced luminance is caused by large temperature variations of the end portions of the surface light source device due to heat dissipation through a mold, which is provided to the both end portions of the discharge spaces 50, and by low currents in the end portions of the surface light source device due to leakage currents through the mold including a dielectric material and a rubber holder. In addition, since a compensation effect generated by overlapped lights in the both end portions of the discharge spaces 50 is relatively low, the luminance in the both end portions of the discharge spaces 50 is rapidly reduced. As a result, when the surface light source device is combined with the liquid crystal display device, a luminance of the liquid crystal display device is further reduced.

### SUMMARY OF THE INVENTION

Embodiments of the present invention provide a surface light source device that has uniform luminance by varying an electrical capacitance.

Embodiments of the present invention provide a backlight unit having the above-mentioned surface light source device as a light source.

In accordance with one aspect of the present invention, a surface light source device includes a light source body and at least two electrodes. The light source body has a plurality of discharge spaces formed along a first direction. The electrodes for generating a dielectric barrier discharge in the discharge spaces are formed on both end portions of an outer face of the light source body along a second direction substantially perpendicular to the first direction. Each of the electrodes has its capacitance that varies along the second direction.

According to one embodiment, each of the electrodes has width that is widened from a central portion of the electrode to both end portions of the electrode. Each of the electrodes may have a stepped shape or a curved shape.

According to another embodiment, each of the electrodes includes an extension portion extending in the second direction, and protruded portions that are protruded from a central portion of the electrode toward a central portion of the light source body.

In accordance another aspect of the present invention, a backlight unit includes a surface light source device, an upper and lower case, an optical sheet, and an inverter. The surface light source device includes a light source body and at least two electrodes. The light source body has a plurality of discharge spaces formed along a first direction. The electrodes for generating a dielectric barrier discharge in the discharge spaces are formed on both end portions of an outer face of the light source body along a second direction substantially perpendicular to the first direction. Each of the electrodes has capacitance that varies along the second direction. The upper and lower cases receive the surface light source device. The optical sheet is interposed between the surface light source device and the upper case. The inverter applies a discharge voltage for driving the surface light source device to the electrodes.

According to the present invention, the electrode has the protruded portions protruded from the central portion and the both end portions of the electrode so that capacitances of the central portion and the both end portions of the electrode may be increased. Thus, luminance in upper and lower end portions of an LCD panel may be relatively increased so that the LCD panel may have uniform luminance. Further, since a central portion of the LCD panel has relatively increased luminance, the LCD panel may display an image having a high resolution.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a plan view illustrating a conventional surface light source device;

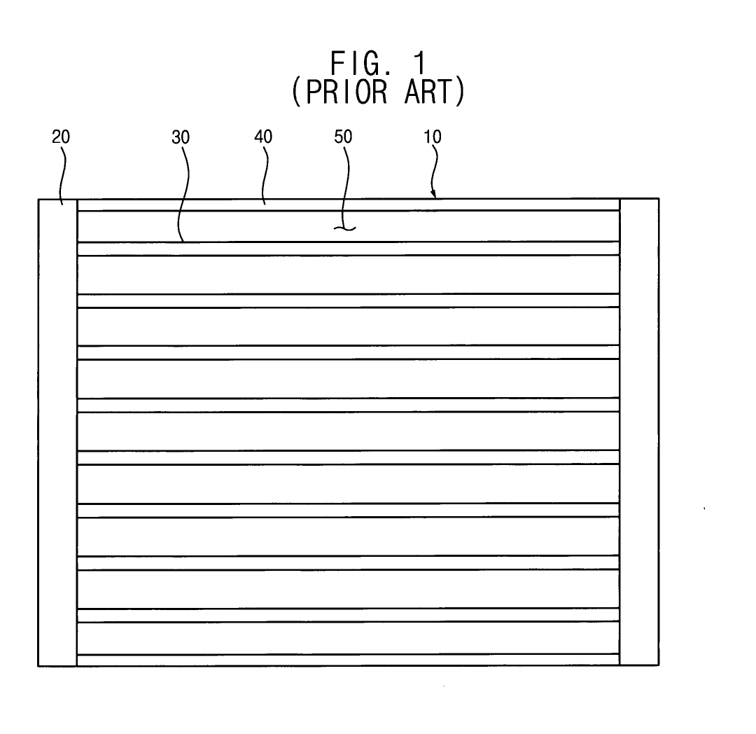

FIG. 2 is a perspective view illustrating a surface light source device in accordance with a first exemplary embodiment of the present invention;

FIG. 3 is a plan view illustrating the surface light source device in FIG. 2;

FIG. 4 is a graph illustrating luminance distributions of the surface light source device in FIG. 2 and a conventional surface light source device;

FIG. 5 is a plan view illustrating a surface light source device in accordance with a second exemplary embodiment of the present invention;

FIG. 6 is a plan view illustrating a surface light source of a third exemplary embodiment of the present invention;

FIG. 7 is a graph illustrating luminance distributions of the surface light source device in FIG. 6 and a conventional surface light source device;

FIG. 8 is a plan view illustrating a surface light source in accordance with a fourth exemplary embodiment of the present invention;

FIG. 9 is a perspective view illustrating a surface light source device in accordance with a fifth exemplary embodiment of the present invention;

FIG. 10 is a perspective view illustrating a surface light source device in accordance with a sixth exemplary embodiment of the present invention; and

FIG. 11 is an exploded perspective view illustrating a backlight unit in accordance with a seventh embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiment 1

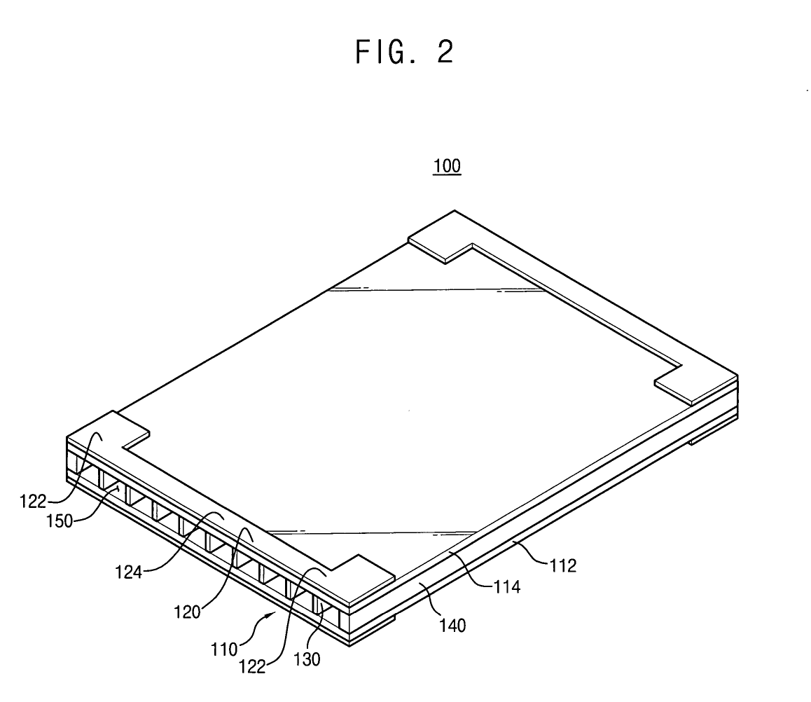

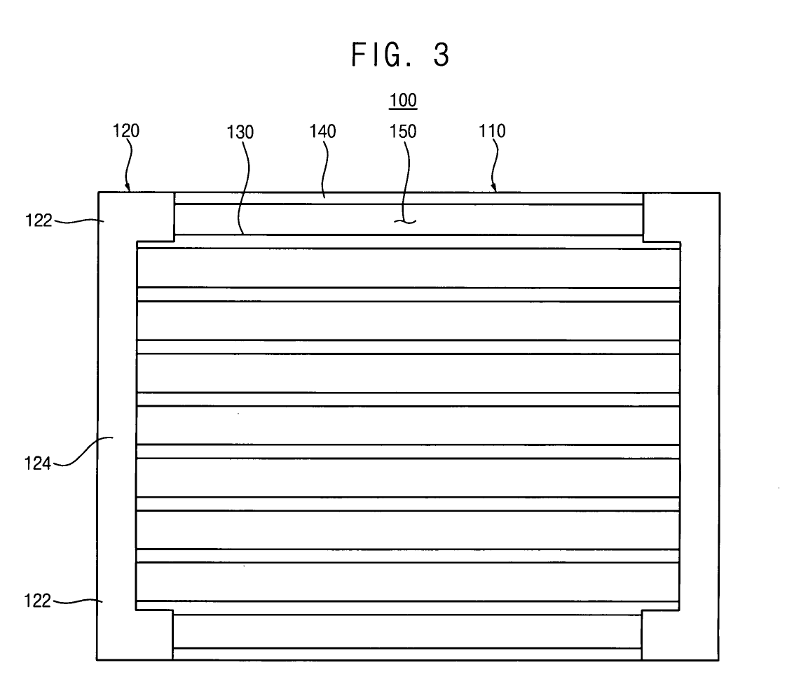

FIG. 2 is a perspective view illustrating a surface light source device in accordance with a first exemplary embodiment of the present invention, and FIG. 3 is a plan view illustrating the surface light source device in FIG. 2.

Referring to FIGS. 2 and 3, a surface light source device 100 of the present embodiment includes a light source body 110 having an inner space into which a discharge gas is injected, and electrodes 120 for applying a discharge voltage to the discharge gas. Examples of the discharge gas include a mercury gas, an argon gas, a neon gas, a xenon gas, etc. These can be used alone or in a combination thereof.

The light source body 110 of the present embodiment is of a partition wall-separated type. Thus, the light source body 110 includes a first substrate 112, a second substrate 114 placed over the first substrate 112, a sealing member 140 interposed between edges of the first and second substrates 112 and 114, and a plurality of partition walls 130 arranged in the inner space to divide the inner space into a plurality of discharge spaces 150.

The first and second substrates 112 and 114, for example, have a rectangular plate shape. The first and second substrates 112 and 114 include a glass material for transmitting a visible light and absorbing an ultraviolet ray. The second substrate 114 includes a light-exiting face through which a light generated in the discharge spaces 150 exits. A first passivation layer (not shown) may be formed on the first substrate 112 and a second passivation layer (not shown) may be formed beneath the second substrate 114.

Additionally, a light reflection layer (not shown) is formed on a surface of the first substrate 112. The light reflection layer may include a titanium oxide (TiO₂) film, an aluminum oxide (Al₂O₃) film, etc. The light reflection layer such as the TiO₂ film or the Al₂O₃ film may be formed by a chemical vapor deposition (CVD) process, a sputtering process, a spray coating process etc. The light reflection layer reflects the visible ray toward the first substrate 112 to the second substrate 114 to enhance a luminance of the surface light source device 100.

Further, a first fluorescent layer (not shown) for converting the ultraviolet ray generated in the discharge space 150 into a visible ray may be formed on the light reflection layer. In addition, a second fluorescent layer (not shown) may be formed beneath a bottom face of the second substrate 114.

The partition walls 130 and the sealing member 140 are attached to the first and second substrates 112 and 114 using a sealing frit (not shown). The partition walls 130 are arranged along a first direction substantially in parallel with each other to form the discharge spaces 150 having a rectangular parallelepiped shape. Both ends of the partition walls 130 make contact with an inner face of the sealing member 140. Thus, each of the discharge spaces 150 is separated from each other.

Therefore, a passage (not shown) for allowing the discharge gas to flow into the discharge spaces 150 is formed through the partition wall 130. In particular, the passage is formed along a direction substantially perpendicular to a lengthwise direction of the partition wall 130.

Alternatively, in order to allow the discharge gas to flow between the partition wall 130 and the sealing member 140, the partition walls 130 may be alternately arranged so that the discharge spaces 150 have a serpentine structure.

The electrodes 120 extend along a second direction substantially perpendicular to the first direction that corresponds to a lengthwise direction of the discharge spaces 150. Thus, the electrodes 120 are substantially perpendicular to the partition walls 130. The electrodes 120 are arranged in the lengthwise direction of the discharge spaces 150 so as to face each other. The electrodes 120 are arranged on both edge portions of each of the discharge spaces 130. In the present embodiment, at least two electrodes 120 are placed on the light source body 110.

The electrodes 120 include a material having a good conductivity. Examples of the electrodes 120 include copper (Cu), nickel (Ni), silver (Ag), gold (Au), aluminum (Al), chromium (Cr), etc. These can be used along or in a combination thereof. The electrode 120 may include a conductive tape having the material as above, which is attached on an outer face of the light source body 110 or a coating layer including a metal powder that is coated on the outer face of the light source body 110.

The electrodes 120 may be arranged on each of outer faces of the first and second substrates 112 and 114. Alternatively, the electrodes 120 may be formed on any one of outer faces of the first and second substrates 112 and 114.

Each of the electrodes 120 includes a central portion 124 having a first width and end portions 122 having a second width wider than the first width. Thus, the both end portions 122 of the electrodes 120 have a stepped portion on a plan view. In the present embodiment, each of the electrodes 120 has one stepped portion. In the present embodiment, the number of the stepped portion and the second width may be variously changed. In the present embodiment, a ratio between the second width and the first width is about 1.1:1 to about 2:1.

Since the widths of the electrode 120 are different from each other in accordance with an extending direction of the electrode 120, capacitances of the electrodes 120 also vary in accordance with the extending direction of the electrode 120. Capacitances in the both end portions 122 are relatively higher than that in the central portion 124. Thus, end portions of the discharge space 150 corresponding to the end portions 122 of the electrodes 120 have a luminance higher than that of a central portion of the discharge space 150 corresponding to the central portion 124 of the electrodes 120.

Therefore, the luminance of the end portions of the discharge space 150 may not be rapidly reduced, although a current applied to the both end portions 122 of the electrode 120 has a tendency to reduce due to a temperature difference between the central portion 124 and the both end portions 122, and a leakage of the discharge gas through a mold including a dielectric material and a rubber holder. Thus, the surface light source 100 may have greatly enhanced luminance uniformity.

Measuring Luminances of Surface Light Source Devices

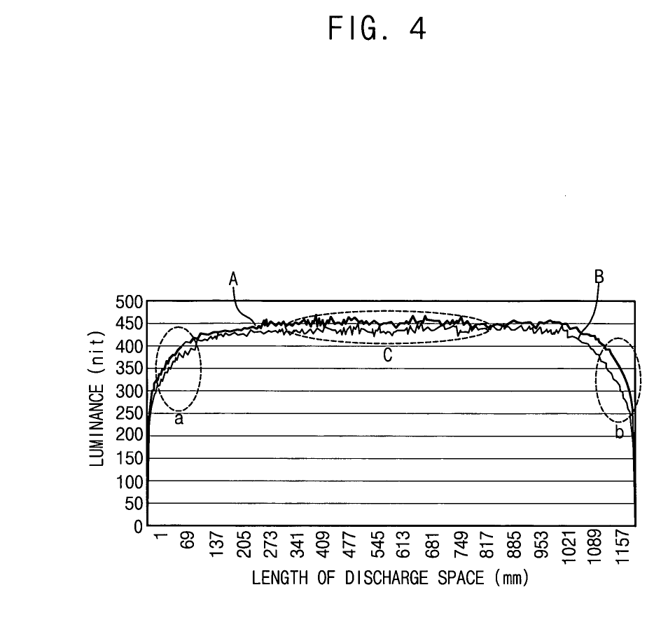

Luminances of the surface light source device 100 in Embodiment 1 and a conventional surface light source device having an electrode, which had a substantially same width, were measured. The measured luminances were shown in FIG. 4

In FIG. 4, a curved line A represents a luminance of the surface light source device 100 in Embodiment 1. The surface light source device 100 included the electrode 120 that had the central portion 124 having the first width and the end portions 122 having the second with wider than the first width. A curved line B indicates a luminance of the conventional surface light source that included the electrode having the uniform width.

As shown in a region “a” and a region “b” of FIG. 4, it can be noted that the surface light source device 100 had a luminance higher than that of the conventional surface light source device. That is, the end portions of the discharge space 150 in the surface light source device 100 in accordance with Embodiment 1 had a luminance higher than that of a discharge space in the conventional surface light source device. Thus, it may be confirmed that the surface light source device 100 in Embodiment 1 had improved luminance uniformity.

Further, as shown in a region “c” of FIG. 4, it can be noted that the curved line A is slightly higher than the curved line B. That is, since the surface light source device 100 had an increased capacitance, a discharge efficiency of the surface light source device 100 was wholly increased. Although, the luminance of the surface light source device 100 in the region “c” was slightly increased, the increased luminance might not have influence on the luminance uniformity of the surface light source device 100. As a result, the surface light source device 100 had an improved central luminance so that a liquid crystal display (LCD) television receiver set having the surface light source device 100 may have improved definition.

### Embodiment 2

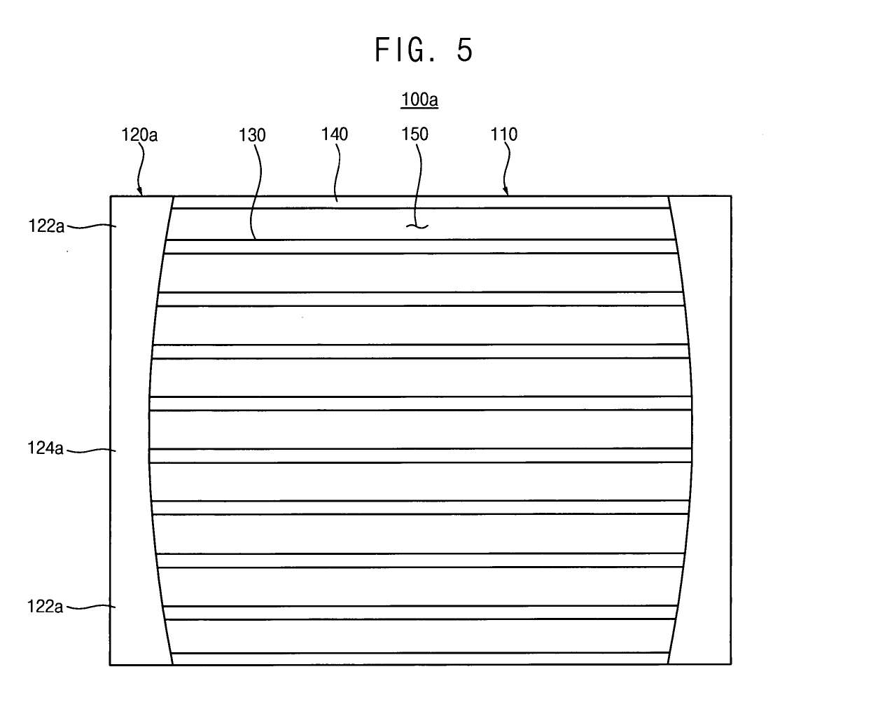

FIG. 5 is a plan view illustrating a surface light source device in accordance with a second exemplary embodiment of the present invention.

Referring to FIG. 5, a surface light source device 100a of the present embodiment includes a light source body 110, electrodes 120a, partition walls 130, a sealing member 140, and discharge spaces 150.

The surface light source device 100a of the present embodiment includes elements substantially identical to those in Embodiment 1 except the electrodes 120a. Thus, the same reference numerals will be used to refer to substantially identical elements in Embodiment 1 and thus any further explanation for the same elements will be omitted.

Further, the electrodes 120a are substantially identical to that in Embodiment 1 except configurations or structure. Thus, any further illustrations with respect to the configurations or structure of the electrodes 120a will be omitted.

Each of the electrodes 120a extends along a first direction substantially perpendicular to a second direction that corresponds to a lengthwise direction of the discharge spaces 150. The electrodes 120a have widths that are gradually widened from a central portion 124a of the electrode 120a to both end portions 122a of the electrode 120a so that the central portion 124a has a first width and the both end portions 122a have a second width wider than the first width. Thus, as shown in FIG. 5, the electrodes 120a have an inner side face having a curved shape on a plan view. Alternatively, the curved shape of the inner side face of each of the electrodes 120a may vary into various curved shapes. A ratio between the second width and the first width may be about 1.1:1 to about 2:1.

Since the widths of the electrode 120a are different from each other in accordance with an extending direction of the electrode 120a, capacitances of the electrodes 120a vary in accordance with the extending direction of the electrode 120. Capacitances in the both end portions 122a are relatively higher than that in the central portion 124a. Thus, both end portions (not shown) of the discharge space 150 corresponding to the end portions 122a of the electrodes 120a have a luminance higher than that of a central portion of the discharge space 150 corresponding to the central portion 124a of the electrodes 120a.

### Embodiment 3

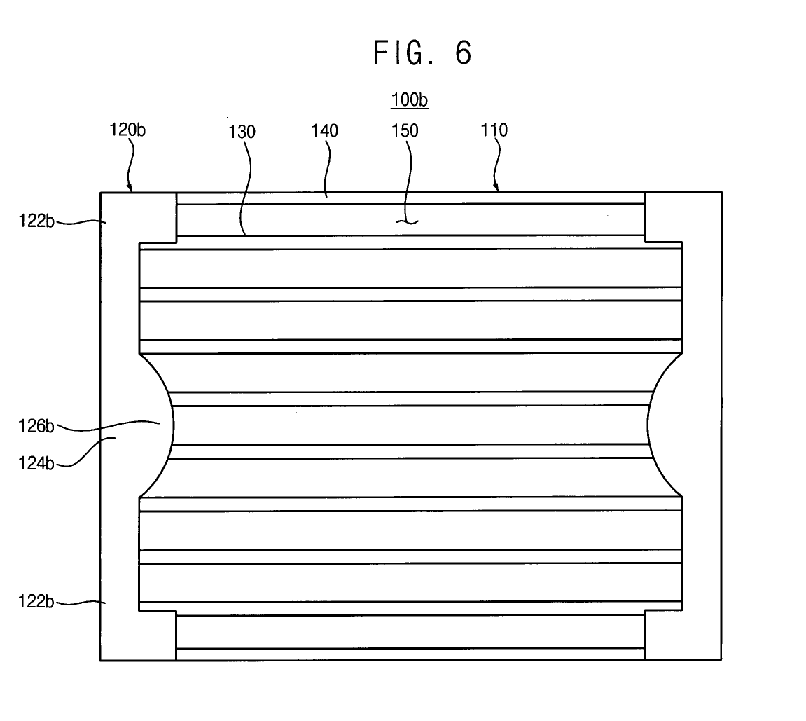

FIG. 6 is a plan view illustrating a surface light source of a third exemplary embodiment of the present invention.

Referring to FIG. 6, a surface light source device 100b of the present embodiment includes a light source body 110, electrodes 120b, partition walls 130, a sealing member 140, and discharge spaces 150.

The surface light source device 100b of the present embodiment includes elements substantially identical to those in Embodiment 1 except the electrodes 120b. Thus, the same reference numerals will be used to refer to substantially identical elements in Embodiment 1 and thus any further explanation for the same elements will be omitted.

Further, the electrodes 120b are substantially identical to that in Embodiment 1 except configurations or structure. Thus, any further illustrations with respect to the configurations or structure of the electrodes 120b will be omitted.

Each of the electrodes 120b has a central portion 124b having a first width and both end portions 122b having a second width wider than the first width. Thus, the both end portions 122b of the electrodes 120b have a stepped portion on a plan view. Here, the number of the stepped portion and the second width may be variously changed. In the present embodiment, a ratio between the second width and the first width is about 1.1:1 to about 2:1.

Further, each of the electrodes 120b has a protruded portion 126b protruded from the central portion 124b of each of the side faces of the electrodes 120b. The protruded portions 126b face each other. The protruded portions 126b have a convex curved shape on a plan view. Thus, the protruded portions 126b prevent a capacitance in a central portion of discharge space 150 corresponding to the central portion 124b of the electrode 120b from rapidly increasing so that a luminance distribution of the surface light source device 100b may not be radically changed.

When the electrodes 120 are placed on a lower face of the first substrate 112 and an upper face of the second substrate 114, respectively, the protruded portions 126b may be provided to the electrodes 120b placed on the lower face of the first substrate 112 and the upper face of the second substrate 114, respectively.

However, in order to provide the surface light source device 100b with uniform luminance, the protruded portion 126b may be selectively formed at any one of the electrodes 120b placed on the first substrate 112 and the second substrate 114, preferably, only the electrodes 120b placed on the second substrate 112.

One protruded portion 126b partially covers about two to about six discharge spaces 150 corresponding to a center portion of the surface light source device 100b. In the present embodiment, the protruded portion 126b has a length of about 0.1 to about 1 times the first width of the central portion 124b of the electrodes 120b. A sum of the first with of the central portion 124b of the electrode 120b and the length of the protruded portion 126b is substantially identical to the second width of the both end portions 122b of the electrodes 120b.

The protruded portion 126b having a convex curved shape is formed at the central portion of the electrode 120b so that the central portion of the surface light source device 100b may have increased luminance without the luminance of surface light source device 100b being affected. Thus, a liquid crystal display (LCD) television receiver set having the surface light source device 100b may have improved definition.

Measuring Luminances of Surface Light Source Devices

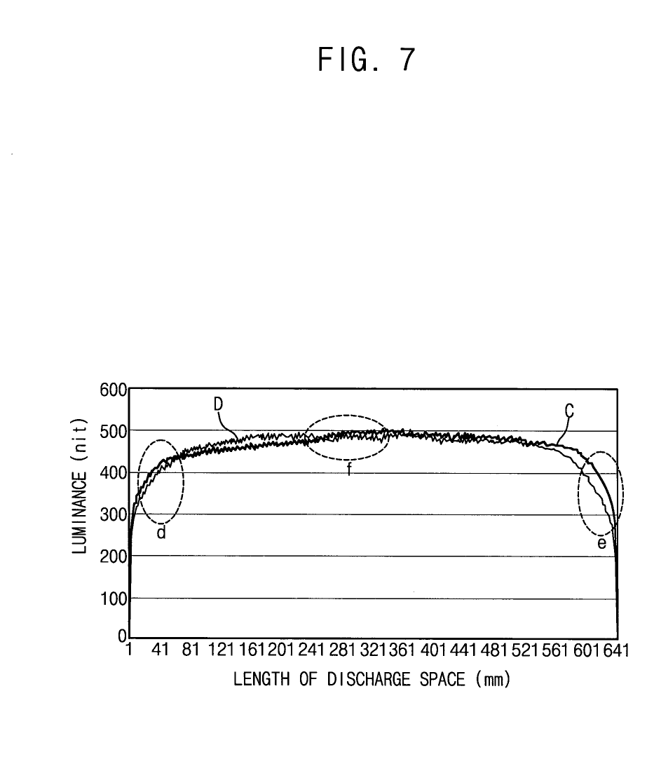

Luminances of the surface light source device 100b in Embodiment 3 and a conventional surface light source device having an electrode, which had a substantially same width, were measured. The measured luminances are shown in FIG. 7

In FIG. 7, a curved line C represents a luminance of the surface light source device 100b in Embodiment 3. The surface light source device 100b included the electrode 120b that had the central portion 124b having the first width and the end portions 122b having the second with wider than the first width and the protruded portion 126b protruded from the central portion 124b. A curved line D indicates a luminance of the conventional surface light source that included the electrode having the uniform width.

As shown in a region “d” and a region “e” of FIG. 7, it can be noted that the surface light source device 100b had a luminance higher than that of the conventional surface light source device. That is, the end portions of the discharge space 150 in the surface light source device 100b in accordance with Embodiment 3 had a luminance higher than that of a discharge space in the conventional surface light source device. Thus, it may be confirmed that the surface light source device 100b in Embodiment 3 had improved luminance uniformity.

Further, as shown in a region “f” of FIG. 7, it can be noted that the curved line C is slightly higher than the curved line D. Since the surface light source device 100b had the protruded portion 126b placed at the center portion of the surface light source device 100b, the luminance of the surface light source device 100b was slightly increased. The luminance was increased by about 5.1 percent that of the conventional surface light source device. The increased luminance might not have influence on the luminance uniformity of the surface light source device 100b. As a result, the surface light source device 100b had an improved central luminance so that a liquid crystal display (LCD) television receiver set having the surface light source device 100b may have improved definition.

### Embodiment 4

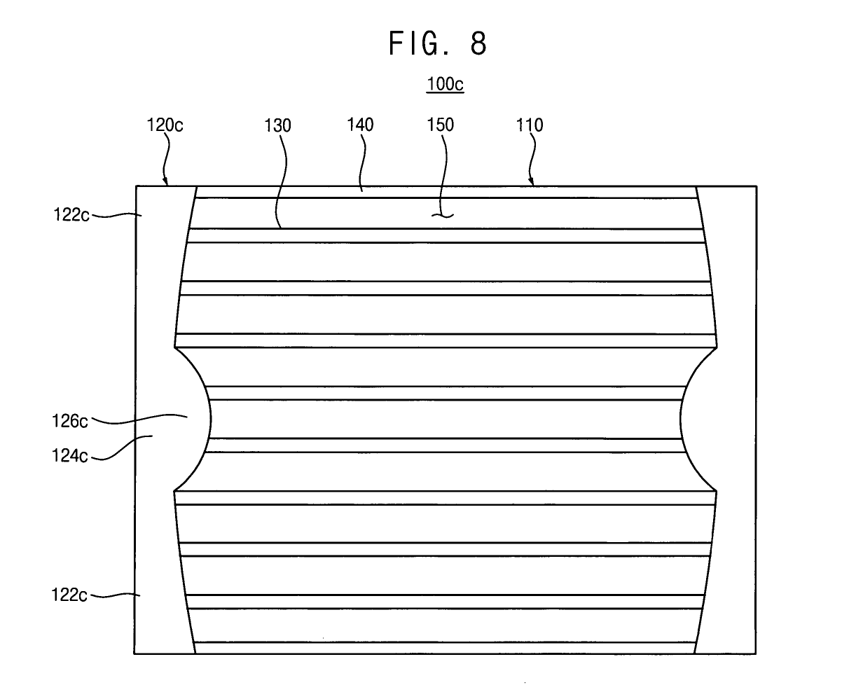

FIG. 8 is a plan view illustrating a surface light source of a fourth exemplary embodiment of the present invention.

Referring to FIG. 8, a surface light source device 100c of the present embodiment includes a light source body 110, electrodes 120c, partition walls 130, a sealing member 140, and discharge spaces 150.

The surface light source device 100c of the present embodiment includes elements substantially identical to those in Embodiment 1 except the electrodes 120c. Thus, the same reference numerals will be used to refer to substantially identical elements in Embodiment 1 and thus any further explanation for the same elements will be omitted.

Further, the electrodes 120c are substantially identical to that in Embodiment 1 except configurations or structure. Thus, any further illustrations with respect to the configurations or structure of the electrodes 120c will be omitted.

Each of the electrodes 120c extends along a first direction substantially perpendicular to a second direction that corresponds to a lengthwise direction of the discharge spaces 150. Each of the electrodes 120c has widths that are gradually widened from a central portion 124c of the electrode 120c to both end portions 122c of the electrode 120c so that the central portion 124c has a first width and the both end portions 122c has a second width wider than the first width. Thus, as shown in FIG. 8, for example, each of the electrodes 120c has an inner side face having a curved shape on a plan view. Alternatively, the curved shape of the inner side face of each of the electrodes 120c may be variously changed. A ratio between the second width and the first width is about 1.1:1 to about 2:1.

Further, each of the electrodes 120c has a protruded portion 126c protruded from the central portion 124c of the inner side face of the electrodes 120c. The protruded portions 126c face each other. The protruded portions 126c have a convex curved shape on a plan view. Thus, the protruded portions 126c prevent capacitance in a central portion of the discharge space 150 corresponding to the central portion 124c of the electrode 120c from rapidly increasing so that a luminance distribution of the surface light source device 100c may not be radically changed.

When the electrodes 120c are placed on a lower face of the first substrate 112 and an upper face of the second substrate 114, respectively, the protruded portions 126c may be provided to the electrodes 120c placed on the lower face of the first substrate 112 and the upper face of the second substrate 114, respectively.

However, in order to provide the surface light source device 100c with uniform luminance, the protruded portion 126c may be selectively formed at any one of the electrodes 120c placed on the first substrate 112 and the second substrate 114, preferably, only the electrodes 120c placed on the second substrate 112.

One protruded portion 126c partially covers about two to about six discharge spaces 150 corresponding to a center portion of the surface light source device 100c. In the present embodiment, the protruded portion 126c has a length of about 0.1 to about 1 times the first width of the central portion 124c of the electrodes 120c. A sum of the first with of the central portion 124c of the electrode 120c and the length of the protruded portion 126c is substantially identical to the second width of the both end portions 122c of the electrodes 120c.

### Embodiment 5

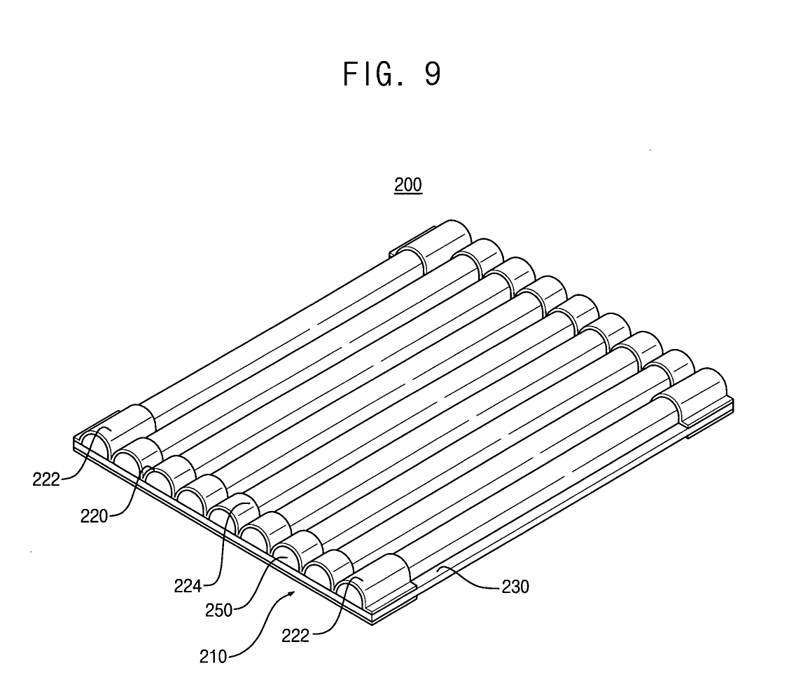

FIG. 9 is a perspective view illustrating a surface light source device in accordance with the fifth exemplary embodiment of the present invention.

Referring to FIG. 9, a surface light source device 200 of the present embodiment includes a light source body 210, electrodes 220, partition walls 230, and a sealing member 240.

The surface light source device 200 of the present embodiment includes elements substantially identical to those in Embodiment 1 except the light source body 210. Thus, any further illustrations of the same elements will be omitted.

Referring to FIG. 9, the light source body 210 of the present embodiment is of a partition wall-separated type. Thus, the light source body 210 includes a first substrate (not shown) and a second substrate (not shown) placed over the first substrate and integrally formed with the partition walls 230. The partition walls 230 make contact with the first substrate to form a plurality of discharge space 250 in which a discharge gas is injected. The discharge space 250 may have a substantially arcuate shape, a rectangular parallel piped shape, a trapezoid shape, a semicircular shape, a triangle shape, etc.

Outermost partition walls 230 are attached to the first substrate using the sealing frit (not shown). The partition walls 230 are arranged along in a first direction. Particularly, the partition walls 230 may have a width of about 0.5 mm to about 2 mm. In order to provide the discharge gas into the discharge spaces 250, a hole in communication with two adjacent discharge spaces 250 may be formed through the partition walls 230 or the partition walls 230 may be arranged in a serpentine structure.

The electrodes 220 are placed on outer faces of the first and second substrates. The electrodes 220 of the present embodiment are substantially identical to those of Embodiment 1. Alternatively, the electrodes 120a, 120b and 120c in accordance with Embodiments 2, 3 and 4 may be employed in the surface light source device 200 of the present embodiment.

### Embodiment 6

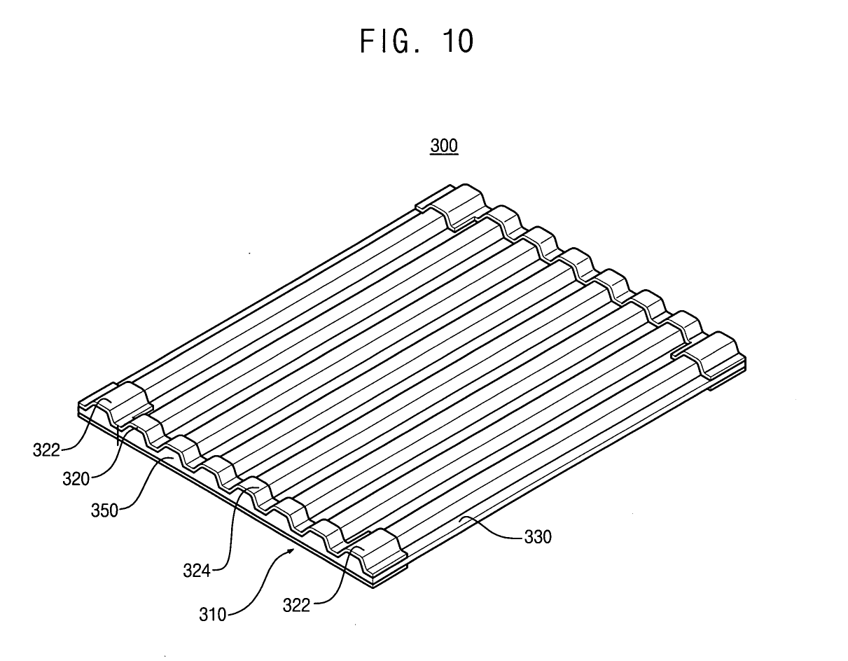

FIG. 10 is a perspective view illustrating a surface light source device in accordance with the sixth exemplary embodiment of the present invention.

Referring to FIG. 10, a surface light source device 300 of the present embodiment includes a light source body 310, electrodes 320, partition walls 330, and discharge spaces 350.

The surface light source device 300 of the present embodiment includes elements substantially identical to those in Embodiment 1 except the light source body 310. Thus, any further illustrations of the same elements will be omitted.

Referring to FIG. 10, the light source body 310 of the present invention is of a partition wall-integrated type. Thus, the light source body 310 includes a first substrate (not shown), and a second substrate (not shown) placed over the first substrate and integrally formed with the partition wall 330. The partition walls 330 make contact with the first substrate to form a plurality of discharge spaces 350 in which a discharge gas is injected. The discharge space 350 has a substantially arcuate shape, a rectangular parallel piped shape, a trapeze shape, a semicircular shape, a triangle shape, etc.

Particularly, in order to suppress a current drifting effect between two adjacent discharge spaces 350 through the partition walls 330, each of the partition walls 330 has a width of about 2 mm to about 5 mm, preferably about 4 mm.

In order to provide the discharge gas into the discharge spaces 350, a hole in communication with two adjacent discharge spaces 350 may be formed through the partition walls 330 or the partition walls 330 may be arranged in a serpentine structure.

The electrodes 320 are placed on the outer face of the first and second substrate. The electrodes 320 of the present embodiment are substantially identical to those in Embodiment 1. Alternatively, the electrodes 120a, 120b and 120c in accordance with Embodiments 2, 3 and 4 may be employed in the surface light source device 300 of the present embodiment.

### Embodiment 7

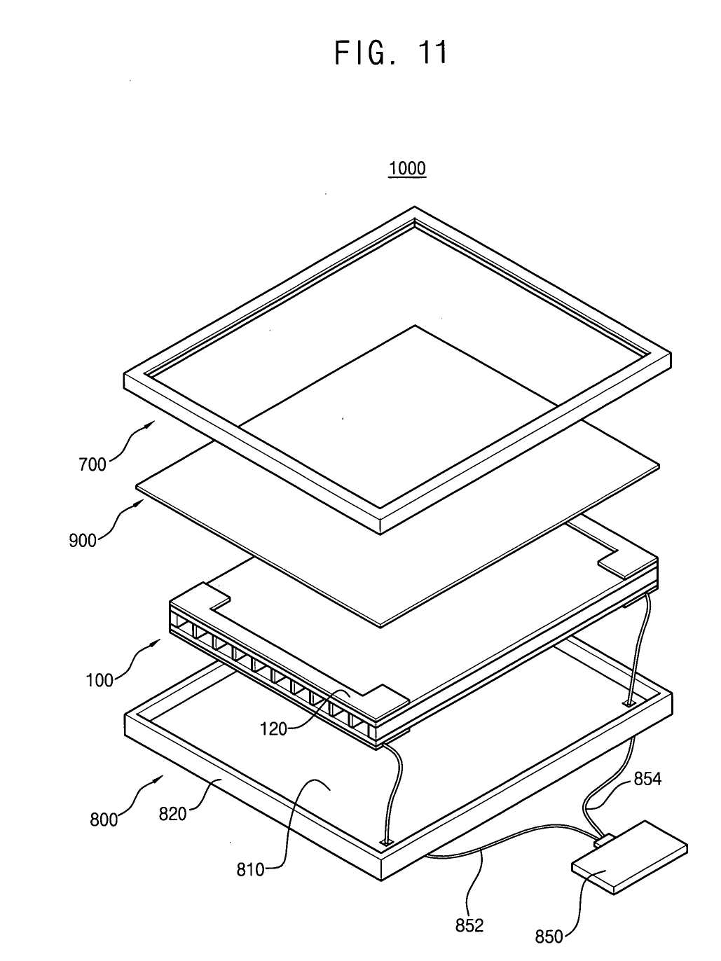

FIG. 11 is an exploded perspective view illustrating a backlight unit in accordance with a seventh embodiment of the present invention.

Referring to FIG. 11, a backlight unit 1000 of the present embodiment includes the surface light source device 100 according to Embodiment 1, upper and lower cases 700 and 800, an optical sheet 900 and an inverter 1300.

The surface light source device 100 is illustrated in detail with reference to FIGS. 2 and 3. Thus, any further illustrations of the surface light source device 100 will be omitted. Further, other surface light source devices in accordance with Embodiments 2 to 7 may be employed in the backlight unit 1000.

The lower case 800 includes a bottom face 810 for receiving the surface light source device 100, and a plurality of side faces 820 extending from an edge of the bottom face 810. Thus, a receiving space for receiving the surface light source device 100 is formed in the lower case 800.

The inverter 850 is arranged under the lower case 800. The inverter 850 generates a discharge voltage for driving the surface light source device 100. The discharge voltage generated from the inverter 850 is applied to the electrodes 120 of the surface light source device 100 through first and second electrical cables 852 and 854.

The optical sheet 900 may include a diffusion sheet (not shown) for uniformly diffusing a light irradiated from the surface light source device 100, and a prism sheet (not shown) for providing straightforwardness to the light diffused by the diffusion sheet.

The upper case 700 is combined with the lower case 800 to support the surface light source device 100 and the optical sheet 900. The upper case 700 prevents the surface light source device 100 from being separated from the lower case 800.

Additionally, an LCD panel (not shown) for displaying an image may be arranged over the upper case 800.

As described above, the surface light source device and backlight unit having the surface light source device have the electrode that has the central portion having the first width and the end portions having the second width wider than the first width. Thus, the capacitance for generating the visible ray varies in accordance with the lengthwise direction of the electrode so that the surface light source device may have improved luminance uniformity.

Further, the electrode has the protruded portion protruded from the central portion of the electrode so that the central portion of the electrode may have improved luminance. Thus, a liquid crystal display (LCD) television receiver set having the surface light source device may have improved definition.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A surface light source device, comprising:
a light source body having a plurality of discharge spaces formed along a first direction; and
at least two electrodes for generating a dielectric barrier discharge in the discharge spaces formed on both end portions of an outer face of the light source body along a second direction substantially perpendicular to the first direction, the electrodes having capacitances that vary along the second direction.

2. The device of claim 1, wherein the electrodes have widths that are widened from a central portion of the electrodes to both end portions of the electrodes.

3. The device of claim 1, wherein the electrodes have a stepped shape or a curved shape.

4. The device of claim 1, wherein the both end portions have a first width of about 1.1 to about 2 times that of a second width of the central portion.

5. The device of claim 2, wherein the electrodes comprises protruded portions that are protruded from the central portion of the electrodes, respectively, and face to each other.

6. The device of claim 5, wherein the protruded portions have a concave curved shape.

7. The device of claim 5, wherein the protruded portion has a protruded length 0.1 to 1 times a width of the central portion.

8. A backlight unit, comprising:
a surface light source device including a light source body that has a plurality of discharge spaces formed along a first direction, and at least two electrodes for generating a dielectric barrier discharge in the discharge spaces that are formed on both end portions of an outer face of the light source body along a second direction substantially perpendicular to the first direction, the electrodes having capacitances that vary along the second direction;
upper and lower cases for receiving the surface light source device;
an optical sheet interposed between the surface light source device and the upper and lower cases; and
an inverter for applying a discharge voltage for driving the surface light source device to the electrodes.
